(19) United States
(12) Patent Application Publication
(10) Pub. No.: US 2024/0257467 A1
(43) Pub. Date: Aug. 1, 2024

(54) System and Method for Optimizing Data Transfers and Rendering of Digital Models

(71) Applicant: Datifex Inc., Toronto (CA)

(72) Inventors: Rajasekaran Thulasidoss, Summerside (CA); Christopher Erickson, Toronto (CA); Sathesh Jayachandran, Chennai (IN)

(21) Appl. No.: 18/161,807

(22) Filed: Jan. 30, 2023

(51) Int. Cl. G06T 17/20; G06F 9/445; G06T 15/00; G06T 19/20; H04L 9/40

(52) U.S. Cl. CPC G06T 17/205; G06F 9/4451; G06T 15/005; G06T 19/20; H04L 63/08; G06T 2200/24; G06T 2210/52; G06T 2219/2016

(57) ABSTRACT

A system and method for optimizing data transfers and rendering of digital models. A system for rendering a model on a display, the system being connected to a network comprising the Internet comprising a user computer, and a remote server. The user computer is configured with a browser program configured for loading and running an application program on the user computer. A remote server configured for storing a plurality of digital assets associated with the model and configured for downloading and uploading one or more of the plurality of digital assets to the application program. The application program includes an optimizer module configured to optimize rendering of a model utilizing said digital assets. The optimizer module including a user role based downloading mechanism having multiple components to retrieve digital assets. The application being configured to render the model based on the retrieved digital assets.

### FIELD OF THE INVENTION

The present invention relates to computer systems and more particularly, to a system and method for optimizing data transfers and rendering of digital models in an industrial application and other data processing applications.

### BACKGROUND OF THE INVENTION

In the art, web applications, i.e. an application loading and running in a web browser, are accessed and loaded over the world wide web (WWW) on the Internet, i.e. the Cloud. Browser based applications have a number of advantages in terms of control over installations, updates, etc. However, browser based applications that utilize data downloaded from the Cloud can experience data bottlenecks which slow down the execution and performance of the application on a user's computer. When the data comprises 3D models and other large chunks of data, the downloading of the data can severely impact the performance of the application to the detriment of the user.

Accordingly, there remains a need for improvements in the art.

### BRIEF SUMMARY OF THE INVENTION

The present disclosure is directed to a method and system for optimizing data transfers and rendering of digital models in an industrial application and other data processing applications.

According to an embodiment, there is provided a system for rendering a model on a display, the system being connected to a network comprising the Internet, said system comprising: a user computer configured with a browser program, said browser program being operatively coupled to the network, and configured for loading an application program over the Internet and running said application program on said user computer, said application program comprising a program for rendering a model, and being responsive to one or more inputs and user actions for manipulating the model; a remote server configured for storing a plurality of digital assets associated with the model, said remote server being coupled to the Internet and configured for downloading and uploading one or more said plurality of digital assets to the application program running on said user computer; said application program being configured for downloading one or more digital assets from said remote server; said application program including an optimizer module, said optimizer module being configured to optimize rendering of a model utilizing said digital assets; said optimizer module including a user role based downloading mechanism, said user role based downloading mechanism including a component configured to authenticate a user based on credentials provided by the user, a component configured to retrieve user permissions in response to said credentials being authenticated, a component configured to retrieve only those digital assets based on said permissions associated with said user; and said application being configured to render the model based on said retrieved digital assets.

According to another embodiment, there is provided a process for rendering a model having a resolution based on a view from a camera of a venue for the rendered model, said process comprising the steps of: preloading digital assets for a low resolution rendition of the model; preloading digital assets for a medium resolution rendition of the model; preloading digital assets for a high resolution rendition of the model; zooming the camera in and out in response to an input; determining if the camera view comprises a long range view, and if yes, rendering a low resolution model based on said low resolution digital assets; determining if the camera view comprises a medium range view, and if yes, rendering a medium resolution model based on said low resolution digital assets; and determining if the camera view comprises a close range view, and if yes, rendering a high resolution model based on said low resolution digital assets.

According to another embodiment, there is provided a computer-implemented process for reducing fidelity of a model being rendered, said process comprising the steps of: loading a model, said model comprising a mesh having a plurality of polygons and a plurality of vertices; loading said mesh into a plurality of regions utilizing a bounding box; dividing said bounding box into smaller and equal boxes; determining a density for said mesh in said bounding box; generating a reference image of said mesh in said bounding box; reducing the number of said plurality of polygons and the number of said plurality of vertices in said mesh, and generating a reduced resolution mesh; generating an image of said reduced resolution mesh; comparing said reduced resolution mesh to said reference image and determining if said reduced resolution mesh matches said reference image within a predetermined setting; if said reduced resolution mesh matches said reference image, then reducing the number of said plurality of polygons and the number of said plurality of vertices in said reduced resolution mesh, and generating another reduced resolution mesh; comparing said another reduced resolution mesh to said reference image and determining if said another reduced resolution mesh matches said reference image within a predetermined setting; if said another reduced resolution mesh does not match said reference image, then utilizing said another reduced resolution mesh for the reduced fidelity model, and uploading said another reduced resolution mesh to a server.

According to another embodiment, there is provided a computer program product for reducing fidelity of a model being rendered, said computer program product comprising: a storage medium configured to store computer readable instructions; said computer readable instructions including instructions for, loading a model, said model comprising a mesh having a plurality of polygons and a plurality of vertices; loading said mesh into a plurality of regions utilizing a bounding box; dividing said bounding box into smaller and equal boxes; determining a density for said mesh in said bounding box; generating a reference image of said mesh in said bounding box; reducing the number of said plurality of polygons and the number of said plurality of vertices in said mesh, and generating a reduced resolution mesh; generating an image of said reduced resolution mesh; comparing said reduced resolution mesh to said reference image and determining if said reduced resolution mesh matches said reference image within a predetermined setting; if said reduced resolution mesh matches said reference image, then reducing the number of said plurality of polygons and the number of said plurality of vertices in said reduced resolution mesh, and generating another reduced resolution mesh; comparing said another reduced resolution mesh to said reference image and determining if said another reduced resolution mesh matches said reference image within a predetermined setting; if said another reduced resolution mesh does not match said reference image, then utilizing said another reduced resolution mesh for the reduced fidelity model, and uploading said another reduced resolution mesh to a server.

According to an exemplary embodiment, the method and system for optimizing data comprises three levels of optimization: optimizing the fidelity of 3D models and objects; optimizing the downloading of assets from the server; optimizing the rendering of 3D models and objects on a web browser.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary operating environment and configuration for implementing and practicing a system and processes according to embodiments of the present disclosure;

FIG. 2A shows in flowchart form an overall process or method for optimizing flow for an administrator according to an implementation of the present disclosure;

FIG. 2B shows in flowchart form an overall process or method for optimizing flow for a user according to an implementation of the present disclosure;

FIG. 3 shows in flowchart from a process or method utilizing a decimation module for reducing the fidelity of a model or object according to an implementation of the present disclosure;

FIG. 4 shows in flowchart from a process or method for loading data based on a user role according to an implementation of the present disclosure;

FIG. 5 shows in flowchart from a process or method for loading data utilizing a lazy loading algorithm according to an implementation of the present disclosure;

FIG. 6A is a screenshot of a 3D rendering of a marine vessel generated according to an implementation of the present disclosure;

FIG. 6B is a screenshot of a thumbnail or lightweight skin 3D rendering of the marine vessel in FIG. 6A generated according to a lazy loading process according to an embodiment of the present disclosure;

FIG. 7 shows in flowchart from a process or method for a building a dynamic model or object according to an implementation of the present disclosure;

FIG. 8A is a screen shot of a first exemplary 3D model suitable for dynamic model building according to an implementation of the present disclosure;

FIG. 8B is a screen shot of a second exemplary 3D model suitable for dynamic model building according to an implementation of the present disclosure;

FIG. 8C is a screen shot of another exemplary 3D model suitable for dynamic model building according to an implementation of the present disclosure;

FIG. 9A is a screen shot of a text mesh generated for a 3D venue according to an implementation of the present disclosure;

FIG. 9B is a screen shot of a 3D venue generated and utilizing the text mesh of FIG. 9A according to an implementation of the present disclosure;

FIG. 10 shows in flowchart from a process or method for offline loading according to an implementation of the present disclosure;

FIG. 11 shows in flowchart from a process or method for on-demand loading according to an implementation of the present disclosure;

FIG. 12A is a screen shot of a first exemplary 3D model built or generated utilizing the on-demand loading process without interior model detail according to an implementation of the present disclosure;

FIG. 12B is a screen shot of the 3D model of FIG. 12A built with interior detail generated and rendered utilizing the on-demand loading process according to an implementation of the present disclosure;

FIG. 13 shows in flowchart from a process or method for determining level of detail for data loading based on the view of a camera according to an implementation of the present disclosure; and

FIG. 14 shows in block diagram form an exemplary implementation of a computer system suitable for implementing the system and processes according to embodiments as described herein.

Like reference numerals indicate like or corresponding elements or components in the drawings.

### DETAILED DESCRIPTION OF THE EMBODIMENTS OF THE INVENTION

Embodiments according to the present disclosure are described below by way of block diagrams and flowcharts, and/or screen shots that are described below by way of a set of screen shots that would be displayed to a user of the system. The system and method for optimizing data transfers and rendering of digital models according to embodiments of the present disclosure is described in the context of an exemplary implementation comprising predictive visualization system. The system and method for optimizing data transfers and rendering of digital models may be integrated with a visualization system, for example, as described in co-pending U.S. patent application [tbd] entitled “A SYSTEM AND METHOD FOR PREDICTIVE VISUALIZATION IN AN INDUSTRIAL APPLICATION” and filed on Jan. 30, 2023, the entirety of which is incorporated herein by reference. It will be appreciated that while the embodiments according to the present disclosure are described in the context of an exemplary implementation or application comprising a navy shipyard, one or more embodiments are also suitable for other industrial applications and/or data processing applications.

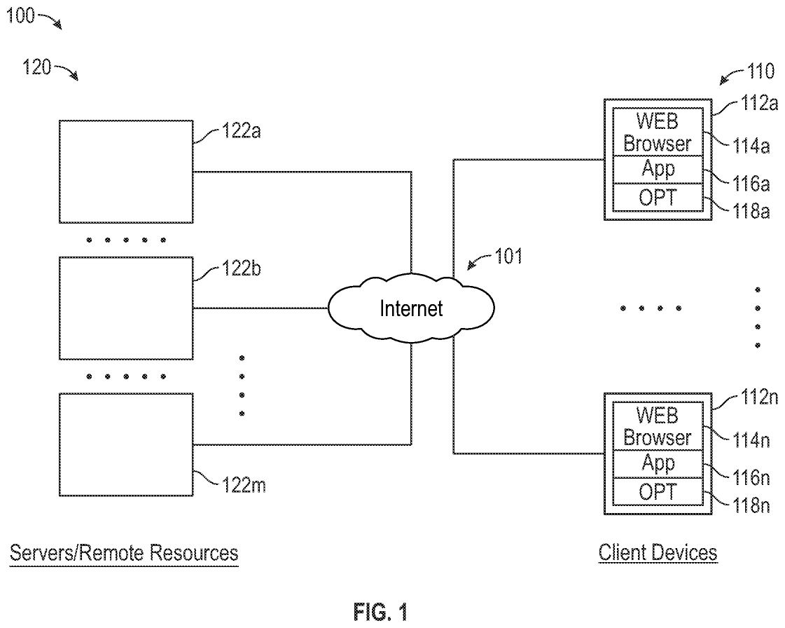

Reference is made to FIG. 1, which shows in diagrammatic form an exemplary operating environment and configuration for implementing and practicing a system and processes according to embodiments of the present disclosure. The operating environment according to an embodiment and indicated generally by reference 100 and comprises clients 110 coupled to remote servers and remote resources 120 available over the “Cloud” or Internet 101. According to an exemplary configuration, the client side 110 comprises one or more computing devices, for instance, desktop computer(s), laptop or notebook computer(s), tablets and other computing devices, machines or appliances, indicated individually by references 112a, 112b . . . 112n. The server side 120 comprises one or more servers and other remote resources indicated individually by references 122a, 122b . . . 122m. Each of the client appliances 112 includes a web browser indicated individually by references 114a, . . . 114n, respectively. The web browser(s) 114 are configured to provide the user to load and run browser-based applications indicated individually by references 116a . . . 116n, and download/upload data from/to the server(s) 122. The application includes a main application window which is configured in the web browser and utilized by the application 116 to display and/or render the models and/or venue and includes a graphical user interface (GUI) configured to allow the user to interact with and manipulate the models and venue using for example inputs from a mouse and/or keyboard or other similar devices. The application 116 is configured with an optimizer module 118 (indicated individually by references 118a . . . 118n) which is configured to execute optimizing processes and methods as described in more detail below in the context of exemplary implementations and embodiments according to the present disclosure.

The performance of the web or browser application loading is impacted by the quantity and size of the 3D models and objects that must be downloaded, which, in turn, affects the time-to-engage for a user. Performance of the application is impacted by the need to draw more polygons per second at higher resolutions. The 3D models are high resolution by default. The 3D models may further include large chunks of other data, for instance, detailed information and data derived from technical drawings, plans and maps required for rendering 3D venues for industrial applications.

The high-fidelity or high resolution models are larger and have more polygons, which slows down the web browser's ability to render them during the execution of the application 116. As will be described in more detail below and according to an exemplary implementation, the application 116 includes a model optimizer module 118 (FIG. 1) configured to detect the density of the polygons on the module and lower the density by reducing the number of vertices or polygons in the mesh layers, as will be described in more detail below.

According to another aspect, the optimizer module 118 is configured to use a “shape maker” function, which is a feature of a dataUX view application. The dataUX view application is utilized to render the 3D models and objects. The shape maker function is utilized to produce low polygon model files, when the geometry of the models is clearly determined. Examples include the rendering of 3D shapes like railcars and containers as pre-determined boxes of varied sizes depending on the incoming meta data, as described in more detail below.

As will be described in more detail below, the embodiments according to the present disclosure are configured to improve the performance-time to user-engagement by retrieving user roles and loading necessary models, loading models from local storage rather than downloading them from the server, loading models progressively at startup, and displaying the required level of complexity of models based on zoom levels, as will be described in more detail below.

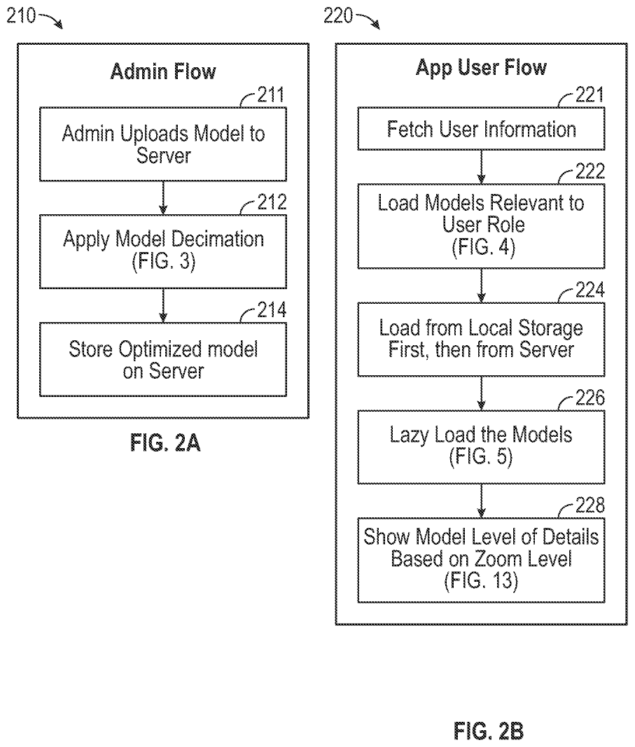

Reference is next made to FIGS. 2A and 2B. FIG. 2A shows a process flow for an administrator according to an exemplary implementation and indicated generally by reference 210. FIG. 2B shows a process flow for a user of the application 116 (FIG. 1) on a client machine 112 (FIG. 1) according to an exemplary implementation and indicated generally by reference 220.

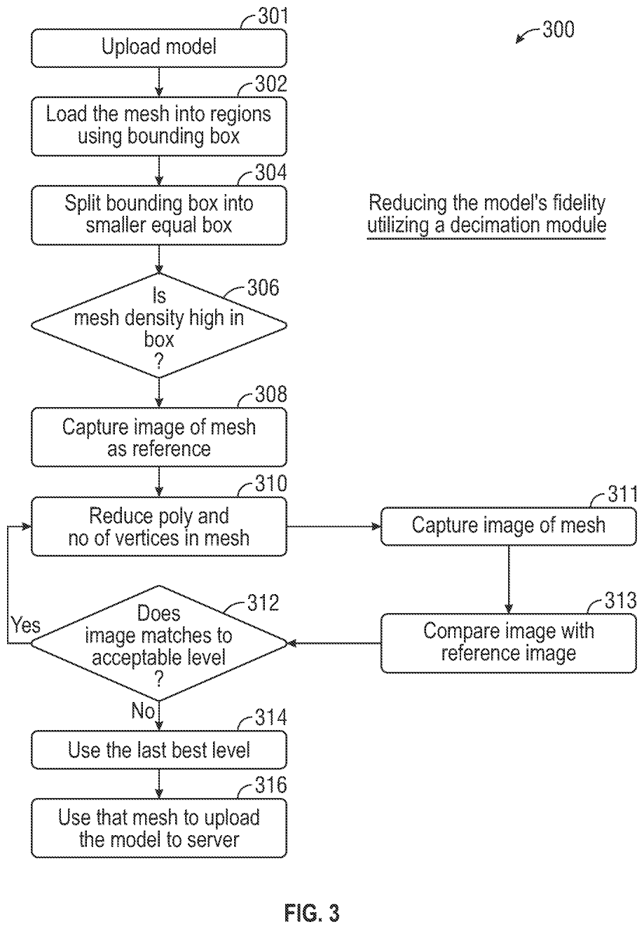

As shown in FIG. 2A, the administrator interfaces directly to the server(s) 122 and utilizing an administrator module or function in the application 116 uploads a 3D model to the server 122 as indicated in block 211 and model decimation is applied to optimize the 3D model as indicated in block 212. A model decimation process 300 according to an embodiment of the present disclosure is described in more detail below with reference to FIG. 3. The optimized 3D model is then stored on the server 122 and available for downloading by the user to the application 116 running on the web browser of user computer, as will be described in more detail below.

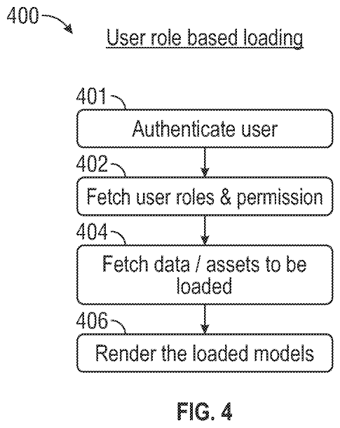

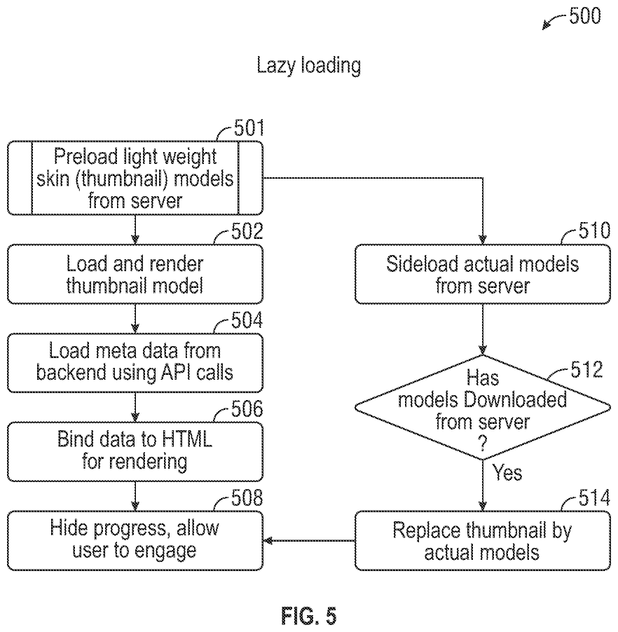

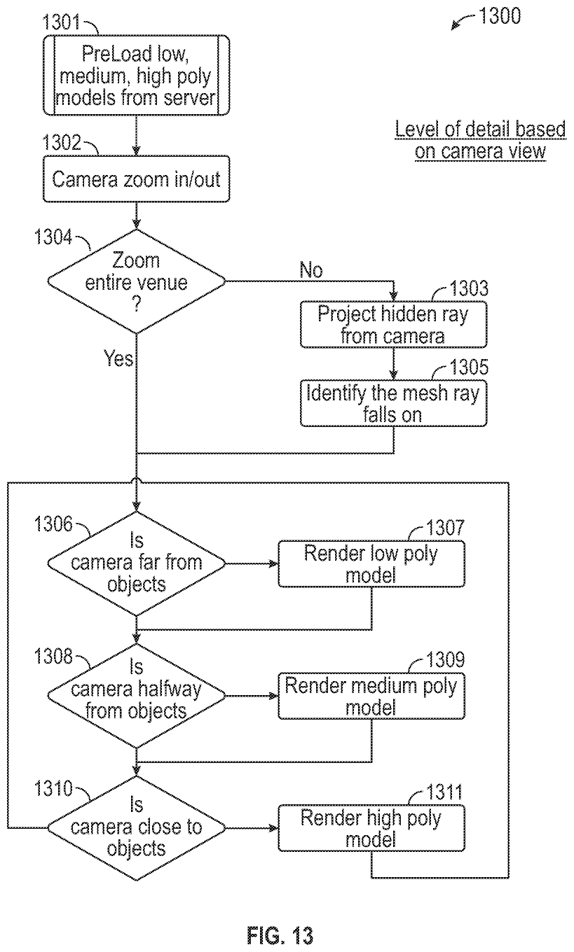

As shown in FIG. 2B, the process flow for a user using the application 116 comprises first fetching user information, including a user role, as indicated in block 221. Next, the application 116, i.e. the optimizer module 118, is configured to load models relevant to the user role, as indicated in block 222. A process for loading models based on a user role 400 is described in more detail below with reference to FIG. 4. The optimizer module 118 is configured to load the relevant models first from local storage (e.g. local computer storage and/or local browser storage), and then from a remote cloud-based server 122 (FIG. 1), as indicated in block 224. The optimizer module 118 is configured to perform a lazy load of the models as indicated in block 226. A lazy load process 500 according to an embodiment of the present disclosure is described in more detail below with reference to FIG. 5. The application flow for a user also includes rendering the 3D model with a resolution or detail level based on a Zoom level or camera view, as indicated in block 228. A process for rendering according to zoom level or camera view 1300 according to an embodiment of the present disclosure is described in more detail below with reference to FIG. 13.

Reference is next made to FIG. 3, which shows an embodiment of the model decimation process 300 according to present disclosure. According to an exemplary implementation, the application 116 is configured to utilize the CPU (central processing unit) of the client computer 112 (FIG. 1) for data and HTML rendering, and further configured to utilize the GPU (graphics processing unit) to render the 3D models and objects, for instance, using WebGL. Due to the large number of polygons in high-resolution 3D models or objects, a powerful GPU is needed to render them quickly. The model decimation process 300 in the application 116 is configured to reduce the polygon count in a mesh to an amount sufficient for rendering without sacrificing the necessary level of mesh detail.

As shown in FIG. 3, the model decimation process 300 is configured to identify 3D model meshes with the highest polygon counts. As shown, the model mesh is first uploaded, as indicated in block 301. The mesh is loaded and split into smaller regions by creating bounding boxes, as indicated in block 302. The number of polygons in each bounding box (e.g. rectangle) is measured, and if necessary the bounding box(es) are split or divided into an equal number of smaller bounding boxes, as indicated in block 304. The bounding box with the highest mesh density is determined and selected for decimation, as indicated in decision block 306. The mesh model is rendered, and the image is captured for reference, as indicated in block 308. Next, the mesh model is decimated again as indicated in block 310 by reducing the number of vertices (and polygons). The decimated mesh model is rendered again, and the image is captured, as indicated in block 311. The captured mesh model is compared against the reference image (i.e. block 308), as indicated in block 313. The optimizer module 118 then determines if the image matches the reference image based on a pre-determined match level, in decision block 312 If the decimated image matches the reference image, i.e. the decimated image closely resembles the reference image according one or more pre-determined parameters or criteria, the decimation operation in block 310 is repeated until the decimated image fails to match the reference image as determined in decision block 310. Once the decimated image no longer matches the reference image, the decimated image, i.e. according to the last best level of decimation, is selected, in block 314 and uploaded to the remote server 122 for storage and Cloud access, as indicated in block 316. According to an exemplary implementation, image comparison libraries are utilized for the comparison operation in decision block 312. The comparison is performed on a pixel-by-pixel basis and a percentile match is generated. The percentile match for an exemplary implementation can typically range from 90-95%.

Reference is next made to FIG. 4, which shows an embodiment of the process for loading models based on a user role 400. The process for loading models 400 is implemented in the optimizer module 118 of the application 114 and configured to limit downloads and rendering of 3D models to those that are necessary for the user to interact with and view in an application, such as a predictive visualization (as described in co-pending U.S. patent application Ser. No. [tbd], filed on January 30-23). According to an exemplary implementation, a user role is determined according the user's logon credentials. According to an exemplary implementation for the navy shipyard application, the user roles comprise: (1) a chit office/runner; a user who only sees or has access to models and data relating to chits; (2) the officer of the day; a user who reviews all of the activities scheduled for the day; and/or (3) maintenance personnel; a user who observes the work packages and defects. As shown in FIG. 4, the process for loading models 400 implemented in the optimizer module 118 authenticates the user during a log-in operation. Based on the user's credentials, the optimizer module 118 retrieves (downloads from the server 122) user roles and permissions. Based on the user role and/or permission(s), the optimizer module 118 fetches or downloads the data and other digital assets to the application 116 executing on the user's computer 112 (FIG. 1) and web browser 114, as indicated in block 404. The downloaded models are then rendered and display, for example, in the main application window, as indicated in block 406 in FIG. 4.

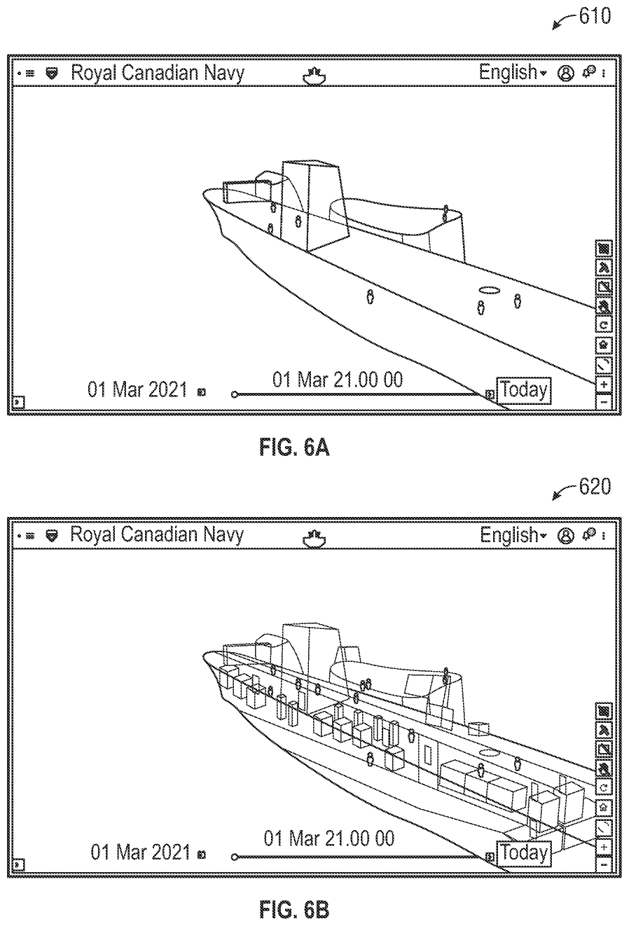

Reference is made to FIG. 5, which shows an embodiment of the process for performing a lazy load 500. The lazy load process 500 is implemented in the optimizer module 118 of the application 116 and configured to achieve an optimal time-to-engagement for the user. According to an exemplary implementation, the lazy load process 500 is configured to preload lightweight skin models (i.e. thumbnails) from the Cloud based server 122 (FIG. 1), as indicated in block 501, which act as placeholders. An exemplary thumbnail or lightweight skin of a 3D model, i.e. a ship, is shown in the screenshot in FIG. 6B and indicated by reference 620. The lightweight skin model 620 is derived from and corresponds to the full resolution 3D model shown in the screenshot in FIG. 6A and indicated by reference 610. It will be appreciated that the thumbnail or lightweight skin rendering of the 3D model is sufficient for the user to use as a placeholder in the 3D venue under construction, while the full resolution 3D model 610 downloads in the background, as indicated in block 510 in FIG. 5. The optimizer module 118 loads (i.e. from local memory) and renders the thumbnail or lightweight skin model 620 in the main application window, for example, as depicted in FIG. 6B. The lazy load process 500 next loads metadata from the server 122 (FIG. 1) using API (Application Program Interface) calls, as indicated in block 504 in FIG. 5. Next, the lazy loader process 500 binds the metadata to HTML tags for rendering the 3D model. It will be appreciated that this configuration allows the user to interact, i.e. engage, with the application 116 and view and manipulate the lightweight skin model 620 (FIG. 6B) using a mouse and/or keyboard on the user computer 112 (FIG. 1), as indicated in block 508. The full resolution 3D model 610 continues to download from the server 122 in the background as indicated in block 510. The lazy load process 500 continues to check if the 3D model 610 (FIG. 6A) has downloaded from the server 122, in decision block 512. Once the downloading of the 3D model(s) from the remote server 122 is completed, the optimizer module 118 is configured replace the thumbnail or lightweight skin model(s) 620 with the full resolution 3D model 610 to allow the user to see all of the finer details of the 3D model 610, as indicated in block 514, and depicted in the screenshot in FIG. 6A.

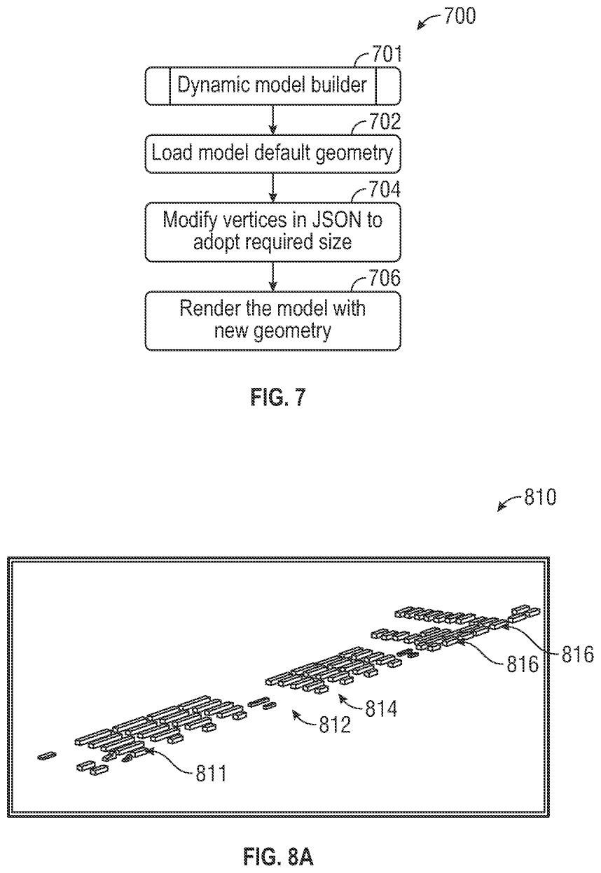

Reference is next made to FIG. 7, which shows an embodiment of a dynamic builder process 700. The dynamic builder process 700 is implemented in the optimizer module 118 of the application 116 and configured to construct models with predictive and simple geometries. The model or venue for an industrial application may comprise shapes that are used for representational purposes, and do not need to comprise detailed mesh in models. For instance, in a railway yard application, railcars and containers have a straightforward or simple rectangular shape, and the principal variable will be the length and/or height of the railway cars and/or the storage containers. A typical railway yard application can comprise upwards of 10,000 railcars and containers in a 3D venue. To utilize mesh models to represent the various objects results in the need to download multiple data heavy assets, which in turn impairs the time-to-engagement performance of the application 116 for the user. The complexity and polygon count of the mesh models can also impact the rendering speed and further impact the performance of the application 116.

According to an exemplary implementation, the dynamic builder process 700 is configured to execute at runtime to construct the models with a pre-defined simple geometry, as indicated in block 701. The dynamic model builder 700 loads the default geometry for the models, for example, a box with simple details or a rectangular cuboid with simple details, as indicted in block 702. The vertices of the models that need to be built have been pre-processed and stored on the server 122 (FIG. 1). Next in block 704, the dynamic builder process 700 is configured to modify the vertices in JSON of the pre-processed models to achieve the required size, e.g. the length of railway cars and/or railway containers. The dynamic builder process 700 is configured to then render the models with the modified or new geometry, as indicated in block 706.

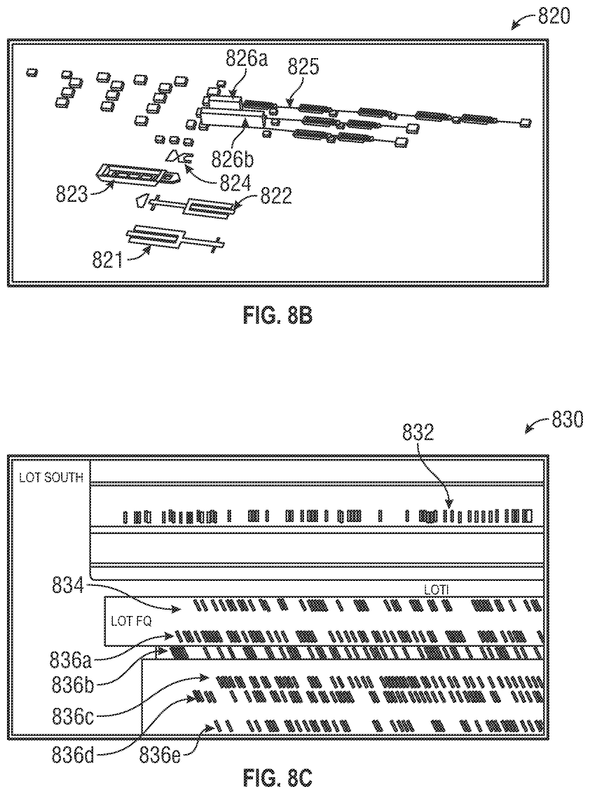

The operation of the dynamic builder process 700 is further explained with reference to the exemplary screenshots in FIGS. 8A to 8C. Reference is made to FIG. 8A, which shows a screenshot of a 3D venue for a container shipping facility in the main application window, and indicated generally by reference 810. The 3D venue 810 for the container shipping facility comprises a plurality of assets including tractor trailers 811 with containers 812 that are loaded on the trailer 811 and containers 814, 816 that will be loaded. The containers 814 comprise simple geometric shapes, i.e. rectangular cuboids with simple mesh textures. Utilizing the dynamic builder process 700, the containers 816 (shown in a darker shade) can be rendered using simple rectangular models. FIG. 8B shows a screenshot of a 3D venue 820 for a railway shipping facility rendered in the main application window. The dynamic builder process 700 can be utilized to simplify the 3D models or objects comprising the 3D venue 820. As depicted, the 3D venue 820 comprises a plurality of assets including railway cars 821, 822, 823 and 824. The railway cars 821 and 822 are configured for transporting a truck trailer 826b. The railway car 823 is configured for transporting a shipping container 826a. As shown in FIG. 8B, a train 825 is created by joining or coupling the railway cars, for example 821, 822 and 823, together. The train 825 is coupled to a locomotive. The dynamic builder process 700 can be utilized to simplify the 3D models or objects comprising the 3D venue 820. Utilizing the dynamic builder process 700 the truck trailer 826b and the shipping container(s) 826a can be rendered using rectangular cuboids with simple mesh textures. FIG. 8C shows a screenshot of a venue 830 for a railway shipping facility rendered in the main application window. As shown, the dynamic builder process 700 has been applied to render the models for shipping containers and/or tractor trailers using rectangular cuboids with simple mesh textures arranged in physical rows in the venue 830. As shown, the venue 830 includes a row of containers 832 rendered as simplified rectangular shapes, a row of containers or tractor trailers 834 rendered as simplified shapes for “Lot F” in the venue 830, rows of containers or tractor trailers, indicated individually by references 836a, 836b, 836c, 836d and 836e, for “Lot FO” in the venue 830.

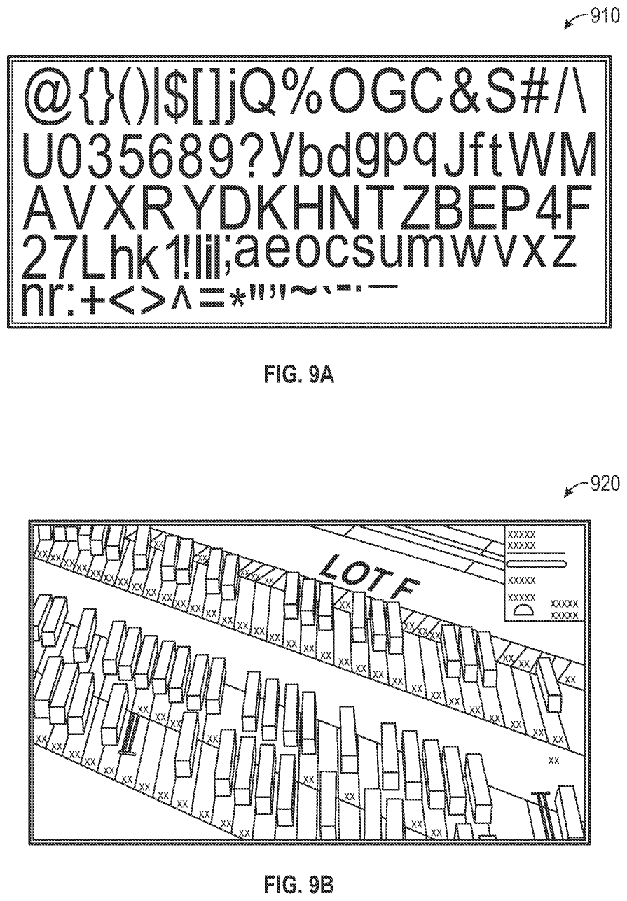

In the rendering of a 3D venue or space, the application 116 may be required to render a large number of labels at runtime. It can be expensive, i.e. resource intensive, to render thousands of labels and create distinct mesh layers for each one. Similarly, the rendering of thousands of HTML data labels in a 3D venue or space for the models can also be resource intensive. For instance, static slots and lots that need to be labelled in the ground plane for a 3D venue will require a lot of processing to be rendered as prebuilt meshes. According to an exemplary implementation, the optimizer module 118 includes a Text Mesh Builder which is configured to create a text mesh for each model and then stitch the text meshes together to form a single mesh. The text mesh builder is configured to assemble the labels in code using a texture which contains a single copy of each character over a transparent background. An exemplary text mesh is depicted in FIG. 9A and indicated generally by reference 910. Each character in a label is then drawn as a single quad (rectangular, shape with four vertices) whose UV coordinates pick the desired character out of the font texture. The text mesh builder is configured to size and position each character-quad to form each label. All of the character quads are put into a single mesh, for example, a mesh configured for the Babylon gaming engine. This lowers the CPU processing overhead once the labels are generated. FIG. 9B shows a screenshot of an exemplary 3D venue 920 comprising a shipping container facility with rows of tractor trailers or containers. The 3D venue 920 includes a text label for “LOT F” generated utilizing the single text mesh generated by the text mesh builder.

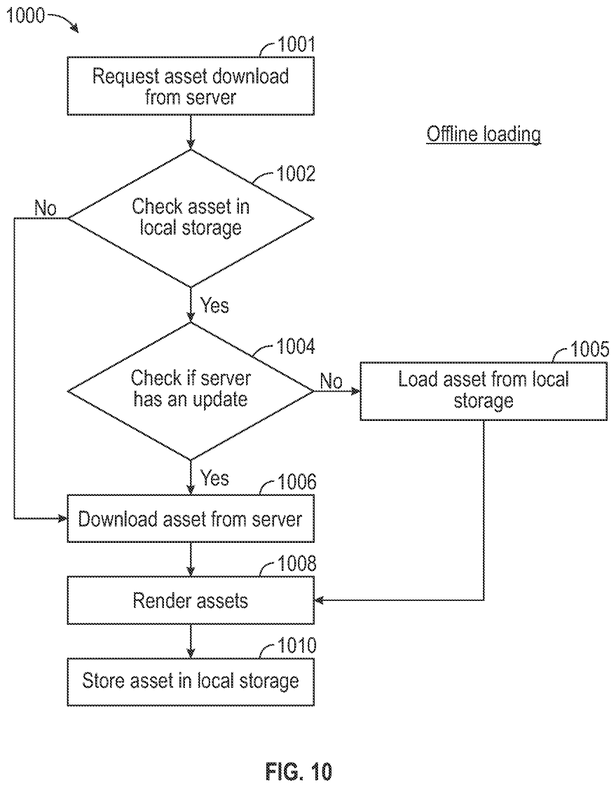

Reference is next made to FIG. 10, which shows an embodiment of an offline loading process 1000. The offline loading process 1000 is implemented in the optimizer module 118 of the application 116 and configured to utilize the local storage database provided by most web browser and store assets offline. As shown in FIG. 10, when the application 116 receives or generates a request to download an asset from the remote server 122 (FIG. 1) in block 1001, the offline loading process 1000 is invoked, and checks if the asset is available in local storage, as indicated by decision block 1002. If the asset is not available locally, then the offline loading process 1000 is configured to download the asset from the remote server 122 as indicated in block 1006. If, on the other hand, the offline loading process 1000 determines that the asset is available locally, then a check is made with the server 122 to determine if the requested asset has been updated, as indicated in decision block 1004. If the asset has been updated, then the optimizer module 118 is configured to download an updated copy of the asset and store the updated asset in the local database storage for the web browser, as indicated in block 1006. The downloaded asset is then rendered in a 3D venue or space, as indicated in block 1008. The rendered asset is stored in the local storage database associated with the web browser, as indicated by block 1010. If the asset has not been updated as determined in decision block 1004, then the offline loading process 1000 is configured to load asset from the local database storage, as indicated in block 1005. The loaded asset is then rendered (block 1008) and stored in local storage (block 1010). It will be appreciated that the offline loading process 1000 improves the time-to-engagement performance because there is no longer a requirement to download all assets (data files) from the remote server 122 (FIG. 1).

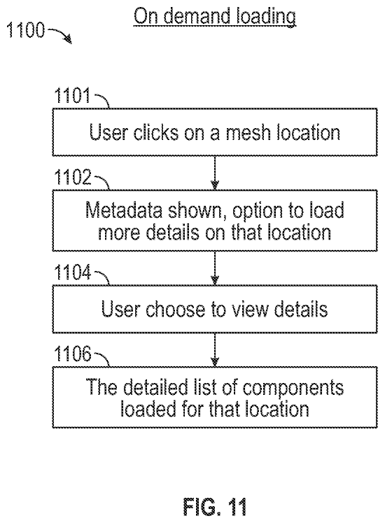

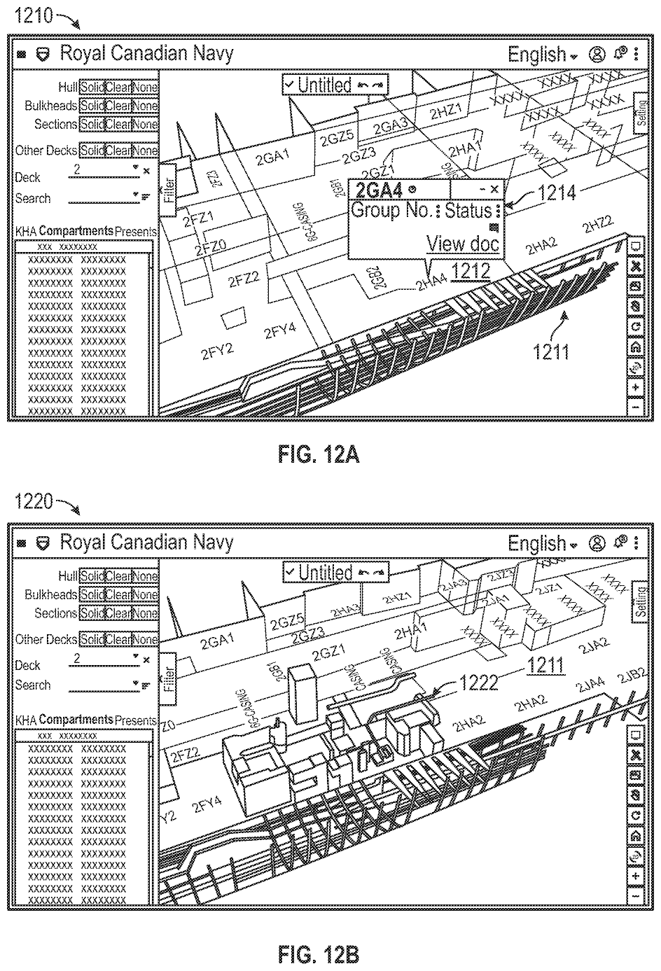

Reference is next made to FIG. 11, which shows an embodiment of an on-demand loading process 1100. The on-demand loading process 1100 is implemented in the optimizer module 118 of the application 116 and configured to download assets from the remote server 122 based on an “as needed” basis. The application 116 does not download certain meshes if the user does not need them, for example, interior or detailing objects for a 3D model. According to an exemplary implementation, the meshes are layered and saved as separate model on the server 122 (FIG. 1). The on-demand loading process 1100 is configured to be responsive to a user click on a mesh location in a 3D venue or space, as indicated in block 1101. An exemplary 3D venue is shown in a screenshot of the main application window in FIG. 12A, and indicated generally by reference 120. The 3D venue 1210 comprises a 3D model of a ship indicated generally by reference 1211. In response to the user click, the on-line demand loading process 1100 shows the metadata associated with the “clicked” location on the 3D model, and provides the option for the user to load more detail, for example, interior or detail objects associated with the model 1211, and located at the clicked location. For the exemplary 3D model 1211 depicted in FIG. 12, the application 116 presents a tag window to allow the user to inspect the ship model 1211 and in response to a mouse click displays a notification, for example, a pop-up window indicated by reference 1214 in response to the user clicking a location indicated by reference 1212. The on-demand loading process 1100 is configured to allow the user to further view the interior details as indicated in block 1104. For example, the 3D model for a ship comprises numerous decks, and each deck will have a number of compartments. The application is configured to allow the user to inspect the compartment detail from each deck, and to click inside a compartment, zoom in, and further see the contents. In FIG. 12B, the click location 1212 corresponds to an engine room and other mechanical equipment, indicated generally by reference 1222. If the user wishes to add the interior detail, for example, based on a double-click action, the on-demand loading process 1100 downloads the selected interior detail and/or detailed list of the interior details available for the clicked location, as indicated in block 1106. The on-demand loading process 1100 is particularly suited for interior detailing because the interior detail data models or assets are typically small files and can be downloaded and rendered almost instantly. This reduces the amount of time needed to download and render the model's interior details.

Reference is next made to FIG. 13, and the process for rendering according to zoom level or camera view 1300. The process for rendering according to zoom level or camera view 1300 is implemented in the optimizer module 118 of the application 116 and configured to render and display the 3D model with the appropriate level of detail based on how close and how far the user can view the model(s) when the camera zooms in and out. According to an exemplary implementation, the process for rendering 1300 comprises three levels of model information: (1) a low level or number of polygons for the model; (2) a medium level or number of polygons for the model; and (3) a high level or number of the model. For instance, an application that needs to render higher-level details on a large venue must render many polygons on the venue. This requires a lot of computing power, which degrade performance of the application for user. When the camera is far away, the user does not need to see every detail, therefore at those zoom settings, presenting the finer information is not necessary. Utilizing the low, medium, and high polygon levels of the model information, the application 116 can tailor the level of detail based on the camera zoom level, as will be described in more detail below with reference to FIG. 13.

As shown in FIG. 13, the process for rendering 1300 pre-loads the low, medium and high polygon (“poly”) models from the remote server 122 (FIG. 1), as indicated in block 1301. Through the application 116, the user zooms the camera in and out, as indicated in block 1301. The application 116 determines if the zoom level is for the entire venue in decision block 1304. If not, the application 116 projects a hidden or invisible ray from the camera in block 1303 and identifies the portion or section of the venue, i.e. the mesh, the ray falls on (i.e. the region of interest for the user), as indicated in block 1305. The application 116 utilizes the detection of a collision between the hidden ray and the mesh to determine the mesh that is being focused on by the camera. The application 116 loads and presents the details associated with the target mesh to the user. This gives user a seamless rendering performance of viewing the details wherever they navigates in the venue. Next, the rendering process 1300 determines the zoom level of the camera. If the camera is zoomed out, i.e. far from the object(s), as determined in decision block 1306, the optimizer module 118 is configured to render the object(s) using the low poly model, as indicated in block 1307. If the camera is zoomed halfway out, as determined in decision block 1308, the optimizer module 118 is configured to render the object(s) using the medium poly model, as indicated in block 1309. If the camera is not zoomed out, i.e. close to the object(s), as determined in decision block 1310, the optimizer module 118 is configured to render the object(s) using the high poly model, as indicated in block 1311. It will be appreciated that the graduated or tiered rendering based on the zoom level can reduce the amount of processing time required, and thereby improve the performance of the application 116 for the user.

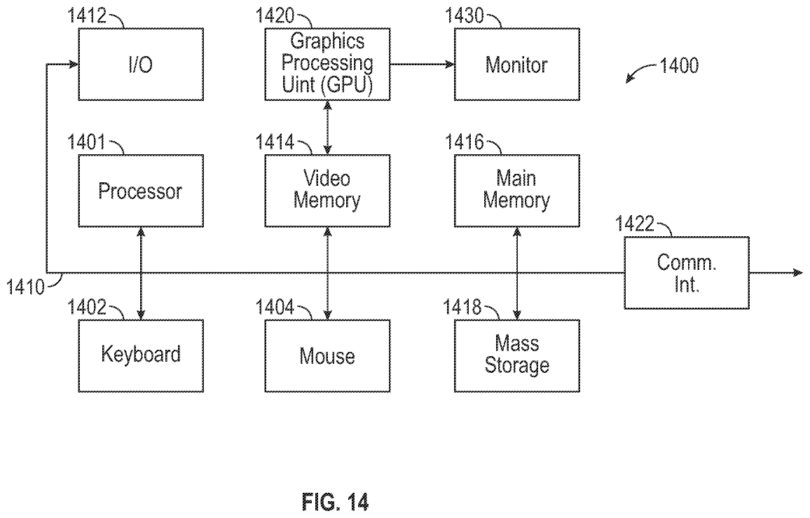

Reference is next made to FIG. 14, which shows an exemplary implementation of a computer system 1400 according to an embodiment and suitable for implementing the system and the other embodiments as described herein.

As shown, the computer system 1400 comprises a processor 1401 and a keyboard 1402 and mouse 1404 coupled to the processor 1401 via a system bus 1410. The keyboard 1402 and the mouse 1404, in one example, allow a user to introduce or provide inputs to computer system 1400 and the processor 1401, for instance, using the user interface (GUI). It will be appreciated that other suitable input devices may be used in addition to, or in place of, the mouse 1404 and/or the keyboard 1402. The computer system 800 may be configured with other input/output (I/O) devices 1412 coupled to the system bus 810, for example, additional display monitor(s), a printer, audio/video (A/V) I/O, etc.

The processor 1401 comprises at least one processor implemented in hardware, or at least in part in hardware, and may further comprise processor modules configured in hardware or in a combination of hardware and software/firmware configured to provide the functions or functionality as described herein.

According to another aspect, the computer system 1400 may include a video memory module 1414, a main memory module 1416 and a mass storage device 1418, which are coupled to the system bus 1410. The mass storage device 1418 may include both fixed and removable media, such as solid state, optical or magnetic optical storage systems and any other available mass storage technology. The system bus 1410 may be configured, for example, with address lines for addressing the video memory 1414 and/or the main memory 1416.

According to another aspect, the system bus 1410 may include a data bus for transferring data between and among the components, such as the processor 1401, the main memory 1416, the video memory 1414 and/or the mass storage device 1418. The video memory 1414 may be a dual-ported video random access memory. One port of the video memory 1414, in one example, is coupled to a graphics processing unit (GPU) 1420 or integrated as an on-chip resource, which is used to drive one or more display monitor(s) indicated generally by reference 1430. The monitor(s) 1430 may be any type of monitor suitable for displaying graphic images, such as a flat panel, or liquid crystal display (LCD) monitor, a cathode ray tube monitor (CRT), or any other suitable data display or presentation device. The processor 1401 may be implemented utilizing any suitable microprocessor or microcomputer.

According to another aspect, the computer system 1400 may include a communication interface 1422, which is coupled to the system bus 1410. The communication interface 1422 provides a two-way data communication coupling via a network link. For example, the communication interface 1422 may be a satellite link, a local area network (LAN) card, a cable modem, and/or wireless interface. In any such implementation, the communication interface 1422 is configured to send and/or receive electrical, electromagnetic or optical signals that carry digital data representing various types of information.

According to another aspect, code received by the computer system 1400 may be executed by the processor 1401 as the code is received, and/or stored in the mass storage 1418, or other non-volatile storage for later execution. In this manner, the computer system 1400 may obtain program code in a variety of forms. Program code may be embodied in any form of computer program product such as a medium configured to store or transport computer readable code or data, or in which computer readable code or data may be embedded. Examples of computer program products include CD-ROM discs, ROM cards, floppy disks, magnetic tapes, computer hard drives, servers on a network, and solid state memory devices. Regardless of the actual implementation of the computer system 1400, the data processing system may execute operations and functions as described herein.

The functionality and features associated with the system and method for optimizing data transfers and rendering of digital models as described above and in accordance with the embodiments may be implemented in the form of one or more software objects, components, or computer programs or program modules in the server and/or the client machines. Further, at least some or all of the software objects, components or modules can be hardcoded into processing units and/or read only memories or other non-volatile storage media in the mobile communication device, server and/or other components or modules depicted in the drawings. The specific implementation details of the software objects and/or program modules will be within the knowledge and understanding of one skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

### LIST OF REFERENCE NUMERALS

100—system operating environment and configuration
101—the Internet or the Cloud
110—clients or users
112—client/user devices
114—web-browser
116—application program
118—optimizer module
120—cloud-based resources
122—servers
210—process flow for an administrator
211—administrator uploads 3D model or object to server
212—apply model decimation
214—store optimized model on server
220—process flow for a user
221—fetch user information
222—load models relevant to user role
224—load from local storage and then from server
226—lazy load the models or objects
228—show model level of details based on Zoom Level
300—process or method for reducing the model's fidelity utilizing a decimation mechanism
301—upload model or object
302—load the mesh into regions using bounding box
304—split bounding box into equal smaller bounding boxes
306—determine if mesh density in the bounding box is high
308—capture image of the mesh as a reference
310—reduce the number of polygons and vertices in the mesh
311—capture image of the mesh
312—determine if captured image still matches the reference image
313—compare captured image with the reference mesh
314—use the best level for the captured image
316—use the mesh to upload the model to the server
400—process or method for user role-based loading
401—authenticate user
402—fetch user roles and/or permission(s)
404—fetch data/assets to be loaded
406—render the loaded models
500—lazy loading process or method
501—pre-load lightweight skin models or thumbnails from the server
502—load and render thumbnail model
504—load metadata from the server using API calls
506—bind data to HTML tags for rendering
508—allow user to manipulate the thumbnail model while the actual model downloads in the background
510—download the actual full resolution model(s) from the server in the background
512—determine if the full resolution model(s) have downloaded from the server
514—replace the thumbnail or lightweight skin model(s) in the venue with the download high resolution model(s)
610—a full resolution 3D object or model
620—a lightweight skin or thumbnail 3d model or object
700—a process or method for building a dynamic model
701—dynamic model builder function
702—load model default geometry
704—modify vertices in JSON to adopt required size
706—render the model with new geometry
810—a rendering of an exemplary 3D object or venue
820—a rendering of another exemplary 3D object or venue
830—a rendering of exemplary 3D objects or venue utilizing cuboids with simple mesh texture
910—an exemplary Text Mesh
920—a rendering of an exemplary 3D object or venue utilizing a Text Mesh
1000—a process or method for offline loading
1001—request assist download from a server
1002—check for asset in local storage
1004—check if server has an updated version of asset
1005—load asset from local storage
1006—download asset from the server
1008—render assets
1010—store asset in local storage
1100—a process or method for on-demand loading
1102—metadata shown, option to load more detail on that location
1104—user chooses to view details
1106—detailed list of components loaded for the location
1210—a rendering of an exemplary 3D object or venue without interior detail
1220—a rendering of the exemplary 3D object or venue with the addition of interior detail
1300—a process or method for preloading and rendering objects based on camera view
1301—pre-load low, medium and high poly models from server
1302—camera zoom in/out
1303—project hidden ray from camera
1304—zoom entire venue?
1305—identify the mesh the RAY falls on
1306—is camera far from objects?
1307—render low poly model
1308—is camera halfway from objects?
1309—render medium poly model
1310—is camera close to objects?
1311—render high poly model
1400—exemplary computer system and hardware components/resources
1401—processor
1402—keyboard
1404—mouse
1410—bus
1412—I/O module or interface
1414—video memory
1416—main computer memory
1418—mass storage device(s)
1420—graphics processing unit (GPU)
1422—communication interface or port
1430—display monitor or panel

What is claimed is:

1. A system for rendering a model on a display, the system being connected to a network comprising the Internet, said system comprising:
a user computer configured with a browser program, said browser program being operatively coupled to the network, and configured for loading an application program over the Internet and running said application program on said user computer, said application program comprising a program for rendering a model, and being responsive to one or more inputs and user actions for manipulating the model;
a remote server configured for storing a plurality of digital assets associated with the model, said remote server being coupled to the Internet and configured for downloading and uploading one or more said plurality of digital assets to the application program running on said user computer;
said application program being configured for downloading one or more digital assets from said remote server;
said application program including an optimizer module, said optimizer module being configured to optimize rendering of a model utilizing said digital assets;
said optimizer module including a user role based downloading mechanism, said user role based downloading mechanism including a component configured to authenticate a user based on credentials provided by the user, a component configured to retrieve user permissions in response to said credentials being authenticated, a component configured to retrieve only those digital assets based on said permissions associated with said user; and
said application being configured to render the model based on said retrieved digital assets.

2. The system as claimed in claim 1, wherein said optimizer module comprises a parallel downloading mechanism, said parallel downloading mechanism comprising a component for downloading low resolution digital assets from said remote server, and application being configured to render the model based on said low resolution digital assets, said parallel downloading mechanism comprising a component for downloading full resolution digital assets from said remote server in parallel, a component configured for determining when all said full resolution assets have been download from said remote server, and a component configured for replacing said low resolution digital assets with said downloaded full resolution digital assets, and said application being configured to render the model based on said downloaded full resolution digital assets.

3. The system as claimed in claim 1, wherein said optimizer module comprises an offline loading mechanism, said offline loading mechanism comprising a component for receiving a request to download a digital asset from said remote server, a component configured for determining if said digital asset is available in local storage, a component configured for downloading said digital asset from said remote server if said digital asset is not available in said local storage and storing said digital asset in said local storage, a component configured for retrieving said digital asset from said local storage if available in said local storage, and said application being configured to render the model based on said retrieved digital asset.

4. The system as claimed in claim 1, wherein said optimizer module comprises an on demand loading mechanism, said on demand loading mechanism comprising a component responsive to a user input on a mesh location on a model rendered by said application, a component configured to display metadata associated with said mesh location in response to said user input, and said demand loading mechanism comprising a component responsive to another user input for selecting said displayed metadata, and a component configured to retrieve digital assets associated with said selected metadata, and said application being configured to render the model with said retrieved digital assets.

5. A computer-implemented process for rendering a model having a resolution based on a view from a camera of a venue for the rendered model, said process comprising the steps of:
preloading digital assets for a low resolution rendition of the model;
preloading digital assets for a medium resolution rendition of the model;
preloading digital assets for a high resolution rendition of the model;
zooming the camera in and out in response to an input;
determining if the camera view comprises a long range view, and if yes, rendering a low resolution model based on said low resolution digital assets;
determining if the camera view comprises a medium range view, and if yes, rendering a medium resolution model based on said low resolution digital assets; and
determining if the camera view comprises a close range view, and if yes, rendering a high resolution model based on said low resolution digital assets.

6. The computer-implemented process as claimed in claim 5, further comprising after zooming the camera in and out, the step of determining if said camera view covers the entire venue, and if not, projecting a hidden ray from the camera onto the venue, and identifying the mesh on the venue, and determining the camera view associated with the mesh.

7. A computer-implemented process for reducing fidelity of a model being rendered, said process comprising the steps of:
loading a model, said model comprising a mesh having a plurality of polygons and a plurality of vertices;
loading said mesh into a plurality of regions utilizing a bounding box;
dividing said bounding box into smaller and equal boxes;
determining a density for said mesh in said bounding box;
generating a reference image of said mesh in said bounding box;
reducing the number of said plurality of polygons and the number of said plurality of vertices in said mesh, and generating a reduced resolution mesh;
generating an image of said reduced resolution mesh;
comparing said reduced resolution mesh to said reference image and determining if said reduced resolution mesh matches said reference image within a predetermined setting;
if said reduced resolution mesh matches said reference image, then reducing the number of said plurality of polygons and the number of said plurality of vertices in said reduced resolution mesh, and generating another reduced resolution mesh;
comparing said another reduced resolution mesh to said reference image and determining if said another reduced resolution mesh matches said reference image within a predetermined setting;
if said another reduced resolution mesh does not match said reference image, then utilizing said another reduced resolution mesh for the reduced fidelity model, and uploading said another reduced resolution mesh to a server.

8. A computer program product for reducing fidelity of a model being rendered, said computer program product comprising:
a storage medium configured to store computer readable instructions;
said computer readable instructions including instructions for,
loading a model, said model comprising a mesh having a plurality of polygons and a plurality of vertices;
loading said mesh into a plurality of regions utilizing a bounding box;
dividing said bounding box into smaller and equal boxes;
determining a density for said mesh in said bounding box;
generating a reference image of said mesh in said bounding box;
reducing the number of said plurality of polygons and the number of said plurality of vertices in said mesh, and generating a reduced resolution mesh;
generating an image of said reduced resolution mesh;
comparing said reduced resolution mesh to said reference image and determining if said reduced resolution mesh matches said reference image within a predetermined setting;
if said reduced resolution mesh matches said reference image, then reducing the number of said plurality of polygons and the number of said plurality of vertices in said reduced resolution mesh, and generating another reduced resolution mesh;
comparing said another reduced resolution mesh to said reference image and determining if said another reduced resolution mesh matches said reference image within a predetermined setting;
if said another reduced resolution mesh does not match said reference image, then utilizing said another reduced resolution mesh for the reduced fidelity model, and uploading said another reduced resolution mesh to a server.
